(19) United States
(12) Patent Application Publication
(10) Pub. No.: US 2018/0089995 A1
(43) Pub. Date: Mar. 29, 2018

(54) INTELLIGENT TRAFFIC CLOUD CONTROL SERVER

(71) Applicant: KYLAND TECHNOLOGY CO.,LTD., Beijing (CN)

(72) Inventors: Fusheng Zhang, Beijing (CN); Guozhen Ma, Beijing (CN); Zhiwei Yan, Beijing (CN)

(21) Appl. No.: 15/367,433

(22) Filed: Dec. 2, 2016

(30) Foreign Application Priority Data
Sep. 26, 2016 (CN) 201610851839.5

(51) Int. Cl. G08G 1/01; G08G 1/081

(52) U.S. Cl. CPC G08G 1/0145; G08G 1/0133; G08G 1/081

(57) ABSTRACT

This application relates to the field of intelligent traffic technology, and particularly to an intelligent traffic cloud control server, so as to address the problem of a poor ability of the control server to manage and control the traffic. The control server according to an embodiment of this application includes: a first CPU configured to receive traffic data, which is provided by at least one of the plurality of field devices and transmitted by a second CPU, to store, analyze, and process the traffic data, and to generate the first control instruction; and the second CPU configured to receive the traffic data provided by the at least one of the plurality of field devices and to transmit the traffic data to the first CPU; and to receive the first control instruction generated by the first CPU, and to control and manage the field device according to the first control instruction.

### CROSS-REFERENCE TO RELATED APPLICATION

This application claims the benefits and priorities of Chinese Patent Application No. 201610851839.5 filed on Sep. 26, 2016, which is hereby incorporated by reference in its entirety.

### FIELD

This application relates to the field of intelligent traffic technology, and particularly to an intelligent traffic cloud control server.

### BACKGROUND

With the development of economy in China, the number of urban population is increasing, which promotes the development of the cities, but brings pressure to the urban traffic. At present, traffic accidents and traffic jams frequently occur in various major cities, thus bringing a lot of inconvenience to our life.

In the relevant art, management and control of a traffic cloud control system on traffic intersections is generally performed by control servers distributed at the traffic intersections and a central system, where each control server at the intersections is equivalent to an intelligent cloud node in the intelligent traffic cloud control system. Specifically, the intelligent cloud nodes acquire real-time traffic data at the corresponding intersections through monitoring devices distributed in respective directions of the intersections, where the real-time traffic data may include vehicle flow, vehicle speeds, traffic violations, and traffic equipment failure, etc. Then the acquired real-time traffic data will be transmitted to the central system, and be analyzed and processed by the central system nodes, so that the central system will transmit control instructions to the intelligent cloud nodes to realize the monitoring and control of traffic conditions at each intersection.

In the relevant art, the intelligent cloud nodes have a poor ability to manage and control the traffic. The intelligent cloud nodes are only responsible for acquiring the traffic data at the corresponding intersections and transmiting the acquired data to the central system, while the central system performs the management and control the traffic of those intersections, as such the central system needs to process a large amount of data, and thus may not adjust in real time control strategies for the traffic condition of those intersections.

### SUMMARY

Embodiments of this application provide an intelligent traffic cloud control server so as to address the problem that the intelligent cloud nodes have a poor ability to manage and control the traffic.

An embodiment of this application provides an intelligent traffic cloud control server, the intelligent traffic cloud control system includes at least a plurality of control servers and a plurality of field devices, wherein the field devices are connected with the control servers over Internet Protocol (IP) address based broadband buses, and the control server includes:
a first CPU configured to receive traffic data, which is provided by at least one of the plurality of field devices, and transmitted by a second CPU, to store, analyze, and process the traffic data, and to generate the first control instruction; and
the second CPU configured to receive the traffic data provided by the at least one of the plurality of field devices, and to transmit the traffic data to the first CPU; and to receive the first control instruction generated by the first CPU, and to control and manage the field device according to the first control instruction.

Optionally the field devices are connected with the control servers over the IP address based broadband buses in such a way that:
the field devices communicate with the control servers over broadband buses supporting IP transmission, and different field devices communicate with each other by IP addressing.

Optionally the intelligent traffic cloud control system further includes a central system, which is connected with the control servers over a network, and is configured to control and manage the control servers; and the first CPU is further configured:
to generate data to be processed according to a result of analyzing and processing the traffic data, and to transmit the data to be processed to the central system; and
the second CPU is further configured:
to receive a second control instruction issued by the central system, and to control and manage the field device according to the second control instruction; wherein the second control instruction is generated by the central system according to the data to be processed.

Optionally the control server further includes:
a network switching module configured to obtain the traffic data provided by the field device, and to transmit the traffic data to the second CPU, and further configured to receive the first control instruction issued by the second CPU and to transmit the first control instruction to the field device, or to receive the second control instruction issued by the second CPU, and to transmit the first control instruction or the second control instruction to the field device.

Optionally the control server further includes:
a network security module configured to transmit the data to be processed which is generated by the first CPU to the central system, and further configured to receive the second control instruction issued by the central system and to transmit the second control instruction to the second CPU.

Optionally the second CPU includes: a signal controlling module configured to detect a signal control state of the field device, and to transmit the signal control state to a signal optimizing module of the first CPU; and a traffic detecting module configured to obtain vehicle data collected by the field device, and to transmit the vehicle data to the signal optimizing module of the first CPU; and
the first CPU includes: the signal optimizing module configured to optimize a control state of the field device according to the signal control state transmitted by the signal controlling module, and the vehicle data transmitted by the traffic detecting module, and to generate the first control instruction.

Optionally the intelligent traffic cloud control system further includes a central system, which is connected with the control servers over a network, and is configured to control and manage the control servers; and the first CPU further includes:
a traffic data processing module configured to analyze and process the signal control state transmitted by the signal controlling module, and the vehicle data transmitted by the traffic detecting module, to generate data to be processed, and to transmit the data to be processed to the central system; and
the signal controlling module is further configured to receive a second control instruction issued by the central system, and to control and manage the field device according to the second control instruction; where the second control instruction is generated by the central system according to the data to be processed.

Optionally the vehicle data detected by the traffic detecting module includes the vehicle video data; and the intelligent traffic cloud control system further includes a central system, which is connected with the control servers over a network, and is configured to control and manage the control servers; and the first CPU further includes:
a video stream processing module configured to analyze and process the vehicle video data transmitted by the traffic detecting module, to generate video data to be processed which is to be provided to the central system, and to transmit the video data to be processed to the central system; and
the traffic detecting module is further configured to transmit the vehicle video data to the video stream processing module of the first CPU.

Optionally the intelligent traffic cloud control system further includes a central system, which is connected with the control servers over a network, and is configured to control and manage the control servers; and the first CPU further includes:
a regulation violation data processing module configured to analyze regulation violation behavior according to the vehicle data transmitted by the traffic detecting module to generate regulation violation data to be processed, to be provided to the central system, and to transmit the regulation violation data to the central system; and
the traffic detecting module is further configured to transmit the vehicle data to the regulation violation data processing module of the first CPU.

Optionally the control servers further includes:
a node interacting module configured to interact with other control servers over a network, and to achieve cooperative control, and/or to take over workload of any failed control server.

In the embodiments of this application, the first CPU is configured to receive the traffic data, which is provided by the field device and transmitted by the second CPU, to store, analyze, and process the data, and to generate the first control instruction; and the second CPU is configured to receive the traffic data provided by the field device, and to transmit the traffic data to the first CPU; and to receive the first control instruction generated by the first CPU, and to control and manage the field device according to the first control instruction. In the embodiments of this application, the intelligent cloud node can acquire the traffic data through the field device, and can store these traffic data locally, and analyze and process the traffic data, and furthermore the intelligent cloud node can manage and control the local field device according to the result of analyzing and processing. As can be apparent, the intelligent cloud node in the embodiments of this application can analyze and process the acquired traffic data locally, and can manage and control the local traffic using the field device, thus improving its ability to manage and control the traffic.

### BRIEF DESCRIPTION OF THE DRAWINGS

FIG. 1 is a schematic structural diagram of an intelligent cloud node in an intelligent traffic cloud control system according to an embodiment of this application;

FIG. 2 is a schematic diagram of an intelligent traffic cloud control system according to an embodiment of this application; and

FIG. 3 is a schematic diagram of control of a local field device by an intelligent cloud node in an intelligent traffic cloud control system according to an embodiment of this application.

### DETAILED DECRIPTION OF THE EMBODIMENTS

In embodiments of this application, a first CPU is configured to receive traffic data, provided by a field device and transmitted by a second CPU, to store, analyze, and process the data, and to generate a first control instruction; and the second CPU is configured to receive the traffic data provided by the field device and to transmit the traffic data to the first CPU, to receive the first control instruction generated by the first CPU, and to control and manage the field device according to the first control instruction. In the embodiments of this application, an intelligent cloud node can acquire the traffic data through the field device, store these traffic data locally, and analyze and process the traffic data, and then the intelligent cloud node can manage and control the local field device according to a result of analyzing and processing. As can be apparent, the intelligent cloud node in the embodiments of this application can analyze and process the acquired traffic data locally, and can manage and control the local traffic using the field device, thus improving its ability to manage and control the traffic.

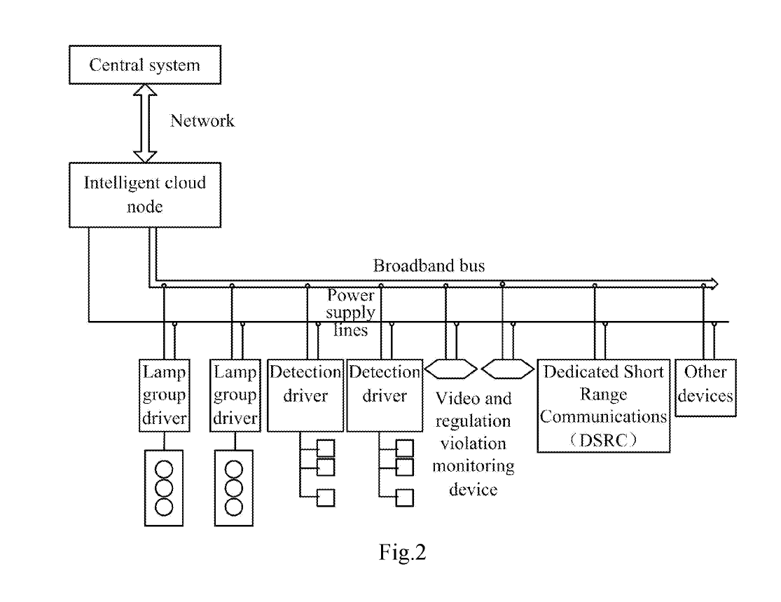

In order to facilitate understanding of an intelligent traffic cloud control system according to the embodiments of this application, firstly the structure of the system will be described here, and as illustrated in FIG. 2, the intelligent traffic cloud control system comprises: at least one control server (intelligent cloud node) arranged at each intersection, and a plurality of field devices communicating therewith over IP address based broadband buses, where the field devices are configured to collect traffic data; and the control servers are configured to process centrally the traffic data collected by the field devices, and to control local traffic through analysis and process of the traffic data. In the embodiments of the application, the control servers can include at least one master control server and a plurality of slave control servers, where the master control server will generate a coordinated control strategy through self-learning and edge computing, and to realize coordinated control in a pre-created customized area; and the slave control server will retrieve a coordinated control strategy from a master control server through cloud system. Furthermore the intelligent traffic cloud control system further includes a central system configured to exchange data with the plurality of control servers over a network, to share the data stored in the control server connected therewith, and to analyze and process the shared data, to generate a coordinated control strategy according to a result of analyzing and processing, and to transmit the coordinated control strategy to a corresponding control server; and the control server is further configured to retrieve the coordinated control strategy from the central system through cloud system, and to operate according to the coordinated control strategy.

The embodiments of this application will be described below in further details with reference to the drawings.

Firstly the central system according to the embodiments of this application will be described here in brevity. An urban intelligent traffic management system generally includes control servers, i.e., intelligent cloud nodes, distributed at respective intersections, and a central system, where the intelligent cloud nodes analyze and process, and then store locally traffic data of the intersections acquired by various field devices, and the central system can retrieve the traffic data from the intelligent cloud nodes periodically (e.g., once a week), or on some appropriate occasion, e.g., the central system can retrieve the traffic data from the intelligent cloud node when there is a traffic jam or a traffic accident occurring at some intersection, or a suspicious vehicle needs to be searched for. The central system at this time can retrieve selectively the traffic data from the intelligent cloud nodes, and can manage and control the traffic of the intelligent cloud nodes according to these acquired traffic data.

In an embodiment of this application, the intelligent traffic cloud control system at least includes a central system, a plurality of control servers, and a plurality of field devices, where the central system is connected with the control servers over a network, the central system is configured to control and manage the control servers, and the field devices are connected with the control servers over IP address based broadband buses.

Here before the control servers are introduced in details, firstly the connection between the field devices and the control servers over the IP address based broadband buses will be described. The field devices communicate with the control servers over broadband buses supporting IP transmission, e.g., two-wire industry Ethernet buses, and the different field devices communicate with each other through IP addressing.

Particularly a broadband bus supporting IP transmission can be arranged in all directions of a traffic intersection where an intelligent cloud node is located, or separate networking cable supporting IP transmission can be arranged respectively in each direction of a traffic intersection where an intelligent cloud node is located, and networking cables arranged in respective directions of the traffic intersection are further connected with a broadband bus supporting IP transmission. Furthermore there are further a plurality of field devices distributed at the intersection where the intelligent cloud node is located, and these field devices are connected respectively with the broadband buses, supporting IP transmission, of corresponding road segments, and monitor vehicles in the respective directions of the intersection. Particularly the field devices can include intelligent devices (e.g., electronic eyes) and non-intelligent devices (e.g., traffic light devices), and the intelligent devices can be connected with the broadband buses supporting IP transmission, so that they can communicate with the second CPU(s), and the non-intelligent devices can be connected with the broadband buses supporting IP transmission through external driver devices, so that they can communicate with the second CPU(s). In order to manage the field devices, the intelligent cloud nodes assign each field device with an IP address, and the field devices set up communication links through IP addressing, so the field devices can be referred to as IP-based field devices. Here each field device corresponds to an IP address, and the different field devices access the data using the respective IP addresses.

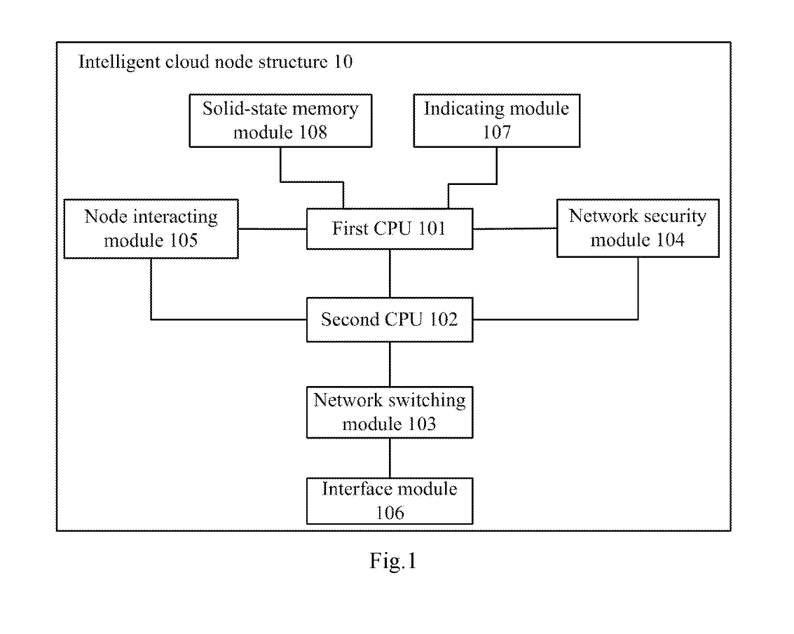

As illustrated in FIG. 1, the structure of an intelligent cloud node 10 according to an embodiment of this application includes:

A first CPU 101 configured to receive traffic data, which is provided by at least one of a plurality of field devices and transmitted by a second CPU, to store, analyze, and process the data, and to generate a first control instruction; and

The second CPU 102 configured to receive the traffic data provided by the at least one of the plurality of field devices, and to transmit the traffic data to the first CPU; and to receive the first control instruction generated by the first CPU, and to control and manage the field device according to the first control instruction.

Optionally the first CPU 101 is further configured:

To generate data to be processed according to a result of analyzing and processing the traffic data, and to transmit the data to be processed to the central system.

The second CPU 102 is further configured:

To receive a second control instruction issued by the central system, and to control and manage the IP-based field device according to the second control instruction; where the second control instruction is generated by the central system according to the data to be processed.

Optionally the intelligent cloud node further includes:

A network switching module 103 is configured to obtain the traffic data provided by the field device and to transmit the traffic data to the second CPU, to receive the first control instruction or the second control instruction issued by the second CPU and to transmit the received instruction to the field device.

Here the network switching module 103 can be connected with the IP-based field device over megabit broadband bus supporting IP transmission, where the IP-based field device transmits the traffic data to the second CPU over the broadband bus supporting IP transmission, and the broadband bus supporting IP transmission can provide the IP-based field device with two power sources of 220 AC and 24 DC dependent upon the type of the IP-based field device.

Optionally the intelligent cloud node further includes:

A network security module 104 is configured to transmit the data to be processed, generated by the first CPU to the central system, and further configured to receive the second control instruction issued by the central system and to transmit the second control instruction to the second CPU, where the network security module 104 transmits the data over a network with gigabit bandwidth.

The functions of the respective modules of the intelligent cloud node according to the embodiment of this application will be described below in further details.

The first CPU can store the traffic data, provided by the field device, transmitted by the second CPU, and then analyze and process these data, and can generate the first control instruction according to the result of analyzing and processing. Furthermore when the first CPU receives a data retrieval instruction issued by the central system through the network security module, then the first CPU can further generate the data to be processed according to the result of analyzing the data locally, and transmit the data to be processed to the central system.

Particularly the functional modules of the first CPU can include a general operating system, a traffic data processing module, a signal optimizing module, a video data processing module, and a regulation violation data processing module, where the base operating system can be configured to store the data provided by the field device, and to provide the intelligent cloud node with a hardware support for real-time calculation of the traffic data; the traffic data processing module is configured to make a statistical analysis, and to process vehicle information collected by the field device; the signal optimizing module is configured to optimize a traffic signal state collected by the field device, for example, if the collected traffic signal state is traffic light time interval at certain intersection, then the traffic light time interval can be optimized according to traffic flow information of the intersection, so that the traffic light time interval is better adapted to the current traffic condition; the video data processing module is configured to process video data collected by the field device; and the regulation violation data processing module is configured to process vehicle data of violating a traffic regulation, acquired by the field device.

The second CPU can receive the traffic data provided by the field device, and transmit the traffic data to the first CPU through the network switching module; and receive the first control instruction generated by the first CPU, and control and manage the field device through the network switching module according to the first control instruction. For example, if statistic results of the first CPU indicate that the average vehicle speed at certain intersection is above a preset vehicle speed threshold, then the first CPU can generate an instruction to add speed bumps to the road segment, according to these obtained statistic results, and transmit the instruction to the second CPU; and furthermore the second CPU can transmit the corresponding instruction to a traffic human operator managing the field device; and in another example, if the statistic results of the first CPU indicate that the traffic flow of certain intelligent cloud node is below a preset traffic flow threshold, then the first CPU can generate an instruction to switch off traffic lights at the intersection, according to these statistic results, and transmit the instruction to the second CPU, and furthermore the second CPU can transmit the corresponding instruction to the corresponding traffic lights device to switch off the related traffic lights.

Furthermore after the central system analyzes and processes the data to be processed, transmitted by the first CPU, if the intelligent cloud node needs to be controlled, then the second CPU can further receive a control instruction issued by the central system through the network security module, and control and manage the field device through the network switching module. For example, if the central system searches for a suspicious vehicle with a license plate number of XX, the central system can transmit an instruction to the first CPU to retrieve the license plate number of XX, then the first CPU will receive an instruction transmitted by the central system to retrieve the license plate number of XX, through the network security module; and furthermore the first CPU can search the locally stored data, and if data with the license plate number of XX are found as a result of the search, then these data can be packed into the data to be processed, to be provided to the central system, and further transmitted to the central system through the network security module. At this time, if the central system analyzes these data to be processed, and discovers that it is likely for the suspicious vehicle with the license plate number of XX to further return to the intersection, the central system can transmit a control instruction to the second CPU to intercept the license plate number of XX, and the second CPU can receive the control instruction transmitted by the central system to intercept the license plate number of XX, through the network security module; and furthermore the second CPU can issue the control instruction to the field device through the network switching module, and a related human operator can discover the suspicious vehicle through the field device, and further intercept the suspicious vehicle.

Particularly the functional modules of the second CPU can include a device configuring and managing module, a signal controlling module, a traffic detecting module, and a service extending module, where the device configuring and managing module is configured to configure some parameters of, and manage operational maintenance of the field device; the signal controlling module is configured to detect a signal control state (e.g., the traffic lights being switched on or off) of the field device, to receive the first control instruction generated by the first CPU as a result of processing the vehicle data and the signal control state, and to issue the first control instruction to the field device; the traffic detecting module is configured to obtain vehicle data from the field device, where the field device acquires these vehicle data through an inductive loop detector, an ultrasonic wave detector, an infrared detector, a radar detector, etc.; and the service extending module is configured to add some extended functions to the intelligent cloud node.

Several interaction processes between the respective modules of the intelligent cloud node according to the embodiment of this application will be described below respectively.

In a first interaction process, the intelligent cloud node controls the local field device.

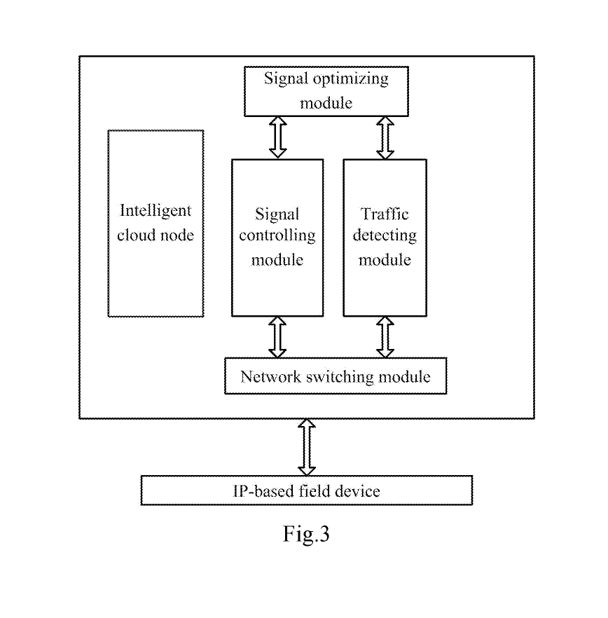

Particularly as illustrated in FIG. 3, the signal controlling module of the second CPU is configured to obtain the signal control state of the field device, and to transmit the signal control state to the signal optimizing module of the first CPU, through the network switching module; and the traffic detecting module of the second CPU is configured to obtain the vehicle data collected by the field device, and to transmit the vehicle data to the signal optimizing module of the first CPU, through the network switching module, where both the vehicle data and the signal control state belongs to the traffic data. Furthermore the signal optimizing module of the first CPU optimizes the control state of the field device according to the signal control state transmitted by the signal controlling module, and the vehicle data transmitted by the vehicle detecting module, and generates the first control instruction. If the first control instruction is configured to control the signal control state of the field device, then the first CPU will transmit the generated first control instruction to the signal controlling module of the second CPU, and the signal controlling module will further issue the first control instruction through the network switching module to adjust the signal control state of the field device; and if the first control instruction is configured to control the traffic flow and other information, then the first CPU will transmit the generated first control instruction to the traffic detecting module of the second CPU, and the traffic detecting module will further issue the first control instruction to the field device through the network switching module, and manage and control the traffic flow and the other information through the field device.

In a second interaction process, the intelligent cloud node receives a control instruction of the central system, and control the local field device.

Particularly the traffic data processing module of the first CPU is configured to analyze and process the signal control state transmitted by the signal controlling module, and the vehicle data transmitted by the traffic detecting module, to generate the data to be processed, and to transmit the data to be processed to the central system; furthermore the signal controlling module of the second CPU is further configured to receive the second control instruction issued by the central system, and to control and manage the field device according to the second control instruction.

In a third interaction process, the intelligent cloud node receives an instruction of the central system to obtain vehicle video data, and transmits the data to be processed to the central system according to the instruction.

The video flow processing module of the first CPU is configured to analyze and process vehicle video data transmitted by the traffic detecting module, to generate video data to be processed, and to transmit the video data to be processed to the central system.

In a fourth interaction process, the intelligent cloud node receives an instruction of the central system to obtain regulation violation data, and transmits the data to be processed to the central system according to the instruction.

The regulation violation data processing module of the first CPU is configured to analyze regulation violation behavior according to the vehicle data transmitted by the traffic detecting module, to generate regulation violation data to be processed, and to transmit the regulation violation data to the central system.

Optionally the intelligent cloud node further includes a node interacting module 105 configured to interact with other control servers over a network, and to realize cooperative control, and/or to take over workload of any failed control server.

Here the plurality of field devices set up their communication links through IP addressing, and the plurality of intelligent cloud nodes are connected over the network, so that if there is a traffic jam occurring at a intersection where an intelligent cloud node is located, then the intelligent cloud node can transmit traffic condition information illustrating a traffic jam to the other intelligent cloud nodes over the network, and the other intelligent cloud nodes will further estimate traffic condition information in the next period of time according to their own current road conditions, and transmit the estimated traffic condition information to a vehicle terminal to direct the traffic, thus enabling coordinated control among the plurality of intelligent cloud nodes. Furthermore if some intelligent cloud node fails, then the intelligent cloud nodes nearby the intelligent cloud node can further take over its traffic data, and report failure information of the intelligent cloud node to the central system, thus lowering the possibility that the intelligent cloud node will lose its ability to manage and control the traffic.

Optionally the intelligent cloud node further includes an interface module 106 configured to provide a traffic data processing interface, a video data processing interface, a regulation violation data processing interface, and a system data interface, which are connected respectively with a traffic data interface, a video data interface, a regulation violation data interface, and a system data interface provided by the central system to thereby exchange data. Where the system data interface of the interface module includes a signal control data processing interface, and an inspection spot data processing interface, and accordingly the system data interface of the central system includes a signal control interface, and an inspection spot interface. Here the interface module provides two types of interfaces, i.e., a USB interface and an RS485 interface, to thereby enable the data processing interface in the interface module to be connected with the interface provided by the central system.

In a real application, the traffic data processing interface of the intelligent cloud node is connected with the traffic data interface of the central system, and configured to transmit the traffic flow, the vehicle speed, whether there is a traffic jam occurring under the road condition, and other information; the video stream processing interface of the intelligent cloud node is connected with the video data interface of the central system, and configured to transmit the video information captured by the electronic eye, the camera, etc., of the intelligent cloud node; the regulation violation data processing interface of the intelligent cloud node is connected with the regulation violation data interface of the central system, and configured to transmit the traffic regulation violation information of the intelligent cloud node; the signal control data processing interface of the intelligent cloud node is connected with the signal control interface of the central system, and configured to transmit the control instruction of the central system for the intelligent cloud node; and the inspection spot data processing interface of the intelligent cloud node is connected with the inspection spot interface of the central system, and configured to transmit the vehicle data collected by a toll station, an overspeed checking station, etc.

Optionally the intelligent cloud node further includes an indicating module 107 configured to indicate whether the field device fails, whether the network connection status of the field device is normal, and whether the data processing interface operates normally. Here if the field device fails, then the intelligent cloud node can detect the particular position of the device according to the IP address thereof, and further change a displayed state to failure, and notify a corresponding administrator of the failure information; and if the field device is dropped from the network, then the administrator will also receive a prompt transmitted by the intelligent cloud node that the device is dropped form the network. Whether the data processing interface operates normally refers to whether there are data output via the data processing interface in a preset period of time, where there are different amounts of data passing different data processing interfaces, so there will also be different periods of time preset for them.

Furthermore the indicating module 107 can indicate whether the network state of the intelligent cloud node is normal, whether the signal output state of the intelligent cloud node is normal, and whether the phase of traffic lights at a intersection is normal, where the network state of the intelligent cloud node refers to whether the intelligent cloud node is online, and if the network state of the intelligent cloud node is offline, then the central system can not manage and control the intelligent cloud node; the signal output state of the intelligent cloud node refers to the signal output state of the inductive loop detector, the ultrasonic wave detector, the infrared detector, the radar detector, etc., detecting the vehicle information, and if some detecting device fails, then there will be no signal output over a corresponding channel; and whether the phase of the traffic lights is normal refers to whether there is collision between passing indications of traffic lights distributed in respective directions of a intersection at the same instance of time, for example, if there are green lamps lightened in both the north-south direction and the east-west direction of the intersection, then the phase of the traffic lights will be abnormal.

Optionally the intelligent cloud node further includes a solid-state memory module 108 configured to store the data from the field device, the data to be processed which is generated by the CPU, and the control instruction issued by the central system, where the solid-state memory module 108 can be embodied as a Solid-State Disk (SSD) memory supporting distributed storage of the data.

Here the solid-state memory module 108 can further store a failure log, a running log, and an operating log of the field device.

In the embodiments of this application, the two functionally separate CPUs, the broadband bus supporting IP transmission, IP addressing mode, video monitoring, traffic detection, etc., are arranged to make the functions of the intelligent cloud node highly integrated, so that the intelligent cloud node can acquire the traffic data through the field device, but also can store locally, and analyze and process these traffic data, and furthermore can manage and control the local field device according to the result of analyzing and processing. As can be apparent, the intelligent cloud node according to the embodiments of this application can analyze and process locally the retrieved traffic data, and can manage and control the local traffic using the field device to thereby improve its ability to manage and control the traffic. Moreover in the embodiments of this application, the broadband bus supporting IP transmission is deployed to thereby make the wiring of the field device more simplified and convenient.

Those skilled in the art shall appreciate that the embodiments of this application can be embodied as a method, a system or a computer program product. Therefore this application can be embodied in the form of an all-hardware embodiment, an all-software embodiment or an embodiment of software and hardware in combination. Furthermore this application can be embodied in the form of a computer program product embodied in one or more computer useable storage mediums (including but not limited to a disk memory, a CD-ROM, an optical memory, etc.) in which computer useable program codes are contained.

This application has been described in a flow chart and/or a block diagram of the method, the device (system) and the computer program product according to the embodiments of this application. It shall be appreciated that respective flows and/or blocks in the flow chart and/or the block diagram and combinations of the flows and/or the blocks in the flow chart and/or the block diagram can be embodied in computer program instructions. These computer program instructions can be loaded onto a general-purpose computer, a specific-purpose computer, an embedded processor or a processor of another programmable data processing device to produce a machine so that the instructions executed on the computer or the processor of the other programmable data processing device create means for performing the functions specified in the flow(s) of the flow chart and/or the block(s) of the block diagram.

These computer program instructions can also be stored into a computer readable memory capable of directing the computer or the other programmable data processing device to operate in a specific manner so that the instructions stored in the computer readable memory create an article of manufacture including instruction means which perform the functions specified in the flow(s) of the flow chart and/or the block(s) of the block diagram.

These computer program instructions can also be loaded onto the computer or the other programmable data processing device so that a series of operational steps are performed on the computer or the other programmable data processing device to create a computer implemented process so that the instructions executed on the computer or the other programmable device provide steps for performing the functions specified in the flow(s) of the flow chart and/or the block(s) of the block diagram.

Although the preferred embodiments of this application have been described, those skilled in the art benefiting from the underlying inventive concept can make additional modifications and variations to these embodiments. Therefore the appended claims are intended to be construed as encompassing the preferred embodiments and all the modifications and variations coming into the scope of this application.

Evidently those skilled in the art can make various modifications and variations to this application without departing from the spirit and scope of this application. Thus this application is also intended to encompass these modifications and variations thereto so long as the modifications and variations come into the scope of the claims appended to this application and their equivalents.

1. An intelligent traffic cloud control server, wherein the intelligent traffic cloud control system comprises at least a plurality of control servers and a plurality of field devices, wherein the field devices are connected with the control servers over IP address based broadband buses, and the control server comprises:
a first CPU configured to receive traffic data, which is provided by at least one of the plurality of field devices and transmitted by a second CPU, to store, analyze, and process the traffic data, and to generate a first control instruction; and
the second CPU configured to receive the traffic data provided by the at least one of the plurality of field devices, and to transmit the traffic data to the first CPU; and to receive the first control instruction generated by the first CPU, and to control and manage the field device according to the first control instruction.

2. The control server according to claim 1, wherein the field devices are connected with the control servers over the IP address based broadband buses in such a way that:
the field devices communicate with the control servers over broadband buses supporting IP transmission, and different field devices communicate with each other by IP addressing.

3. The control server according to claim 1, wherein the intelligent traffic cloud control system further comprises a central system, which is connected with the control servers over a network, and is configured to control and manage the control servers; and the first CPU is further configured:
to generate data to be processed according to a result of analyzing and processing the traffic data, and to transmit the data to be processed to the central system; and
the second CPU is further configured:
to receive a second control instruction issued by the central system, and to control and manage the field device according to the second control instruction; wherein the second control instruction is generated by the central system according to the data to be processed.

4. The control server according to claim 3, wherein the control server further comprises:
a network switching module configured to obtain the traffic data provided by the field device, and to transmit the traffic data to the second CPU, and further configured to receive the first control instruction issued by the second CPU and to transmit the first control instruction to the field device, or to receive the second control instruction issued by the second CPU and to transmit the second control instruction to the field device.

5. The control server according to claim 3, wherein the control server further comprises:
a network security module configured to transmit the data to be processed which is generated by the first CPU to the central system, and further configured to receive the second control instruction issued by the central system and to transmit the second control instruction to the second CPU.

6. The control server according to claim 1, wherein:
the second CPU comprises: a signal controlling module configured to detect a signal control state of the field device, and to transmit the signal control state to a signal optimizing module of the first CPU; and a traffic detecting module configured to obtain vehicle data collected by the field device, and to transmit the vehicle data to the signal optimizing module of the first CPU; and
the first CPU comprises: the signal optimizing module configured to optimize a control state of the field device, according to the signal control state transmitted by the signal controlling module and the vehicle data transmitted by the traffic detecting module, and to generate the first control instruction.

7. The control server according to claim 6, wherein the intelligent traffic cloud control system further comprises a central system, which is connected with the control servers over a network, and is configured to control and manage the control servers; and the first CPU further comprises:
a traffic data processing module configured to analyze and process the signal control state transmitted by the signal controlling module, and the vehicle data transmitted by the traffic detecting module, to generate data to be processed, and to transmit the data to be processed to the central system; and
the signal controlling module is further configured to receive a second control instruction issued by the central system, and to control and manage the field device according to the second control instruction; wherein the second control instruction is generated by the central system according to the data to be processed.

8. The control server according to claim 6, wherein the vehicle data detected by the traffic detecting module comprises the vehicle video data; and the intelligent traffic cloud control system further comprises a central system, which is connected with the control servers over a network, and is configured to control and manage the control servers; and the first CPU further comprises:
a video stream processing module configured to analyze and process the vehicle video data transmitted by the traffic detecting module, to generate video data to be processed which is to be provided to the central system, and to transmit the video data to be processed to the central system; and
the traffic detecting module is further configured to transmit the vehicle video data detected to the video stream processing module of the first CPU.

9. The control server according to claim 6, wherein the intelligent traffic cloud control system further comprises a central system, which is connected with the control servers over a network, and is configured to control and manage the control servers; and the first CPU further comprises:
a regulation violation data processing module configured to analyze regulation violation behavior according to the vehicle data transmitted by the traffic detecting module, to generate regulation violation data to be processed, and to transmit the regulation violation data to the central system; and
the traffic detecting module is further configured to transmit the vehicle data to the regulation violation data processing module of the first CPU.

10. The control server according to claim 1, wherein the control server further comprises:
a node interacting module configured to interact with other control servers over a network, and to achieve cooperative control, and/or to take over workload of any failed control server.
